(19) United States
(12) Patent Application Publication
(10) Pub. No.: US 2023/0287918 A1
(43) Pub. Date: Sep. 14, 2023

(54) CONNECTOR FOR CONNECTING, WITHOUT TOOLS, TWO PANELS AT RIGHT ANGLES AND ACCOMPANYING PANEL ASSEMBLY

(71) Applicant: Häfele Berlin GmbH & Co KG, Berlin (DE)

(72) Inventor: Robert Birkner, Berlin (DE)

(73) Assignee: Häfele Berlin GmbH & Co KG, Berlin (DE)

(21) Appl. No.: 18/321,930

(22) Filed: May 23, 2023

Related U.S. Application Data
(63) Continuation of application No. PCT/EP2021/076764, filed on Sep. 29, 2021.

(30) Foreign Application Priority Data
Nov. 23, 2020 (DE) 20 2020 106 708.7

(51) Int. Cl. F16B 12/20

(52) U.S. Cl. CPC F16B 12/2036; F16B 2012/209; F16B 2012/2072

(57) ABSTRACT

A connector for connecting without tools two panels has a pot-like housing with a radially outwardly protruding expansion sleeve. A clamping lever supported in the housing pivots about a pivot axis between a non-tensioned starting position and a tensioned end position. A tensioning contour extends eccentrically with respect to the pivot axis. A tension bolt has a bolt shaft, with a first bolt end being a first bolt head which is thickened with respect to the bolt shaft and is in the expansion sleeve. A second bolt end being a second bolt head is thickened with respect to the bolt shaft and is arranged inside the housing. The second bolt head is engaged from behind by the eccentric tensioning contour of the clamping lever in the tensioned starting position and is pulled in the direction away from the expansion sleeve. The expansion sleeve is expanded by the first bolt head.

### CROSS-REFERENCE TO RELATED APPLICATIONS

This continuation application claims priority to PCT/EP2021/076764 filed on Sep. 29, 2021 which has published as WO 2022/106103 A1 and also the German application number 20 2020 106 708.7 filed on Nov. 23, 2020, the entire contents of which are fully incorporated herein with these references.

### DESCRIPTION

### Field of the Invention

The invention relates to an eccentric connector for connecting without tools two panels at an angle, in particular at right-angles, with respect to each other, and an associated panel arrangement.

### Background of the Invention

Eccentric connectors are sufficiently known and are, for example, used when connecting two furniture panels. Such an eccentric connector comprises a pot-like housing having a tightening element which is rotatably supported therein and which has an eccentric tightening contour with respect to the rotation axis. The eccentric connector is inserted with the housing into a surface hole in one, first furniture panel and the bolt is anchored in an end hole in the other, second furniture panel. The bolt is introduced with the bolt head thereof into the housing of the eccentric connector and subsequently the tightening element is rotated by means of a tool, whereby the eccentric tightening contour engages behind the bolt head and pulls it into the housing interior until the two furniture panels are tensioned with respect to each other.

### SUMMARY OF THE INVENTION

In contrast, an object of the invention is to provide an eccentric connector which can be operated without tools.

This object is achieved according to the invention by a connector for connecting without tools two panels which are at an angle, in particular at right-angles, with respect to each other, comprising a pot-like housing having a radially outwardly protruding expansion sleeve, a clamping lever which is supported in the housing so as to be able to be pivoted about a pivot axis between a non-tensioned starting position and a tensioned end position and which has a tensioning contour which extends eccentrically with respect to the pivot axis, and a tension bolt having a bolt shaft, having a first bolt end in the form of a first bolt head which is expanded with respect to the bolt shaft and which is arranged in the expansion sleeve, and having a second bolt end in the form of a second bolt head which is expanded with respect to the bolt shaft and which is arranged inside the housing, wherein the second bolt head, when viewed in the direction away from the expansion sleeve, is engaged from behind by the eccentric tensioning contour of the clamping lever in the tensioned starting position and is pulled in the direction away from the expansion sleeve whereby the expansion sleeve is expanded by the first bolt head.

According to the invention, by manually pivoting the clamping lever the expansion sleeve is expanded by the first bolt head. Optionally in this instance, the housing can also be expanded by the first bolt head.

Preferably, the clamping lever in the non-tensioned starting position protrudes from the housing upper side upwardly, for example, perpendicularly, and extends in the tensioned end position parallel with the housing upper side, for example, in a state flush with the housing upper side.

In a particularly preferred manner, the first bolt head is tapered in the direction toward the second bolt head, in particular tapered in a conical manner, and the second bolt head is in the form of a spherical or conical head or a transverse bolt which is angled at right-angles with respect to the bolt axis.

Advantageously, the housing has at least one bearing opening, in which the cylindrical lever end, which extends transversely relative to the lever axis, of the clamping lever is pivotably supported about the pivot axis. In the case of two mutually facing bearing openings, the housing may have therebetween a central wall which can in particular close a slot of the clamping lever in the end position of the clamping lever. Furthermore, the central wall may optionally have a guiding contour for the second bolt head, which guiding contour is preferably arranged on a resilient tongue of the central wall and is consequently constructed to be able to be resiliently deflected.

Preferably, the eccentric tensioning contour is arranged internally on a transverse opening of the housing-side lever end of the clamping lever in a circumferential or pivoting direction of the housing-side lever end. The transverse opening may in this instance be in the form of a slit-like slotted guiding member with the eccentric tensioning contour and with an eccentric pressure contour for the second bolt head.

In order to expand the housing, the housing may have a central longitudinal slot and the tension bolt may have between the two bolt ends thereof two mutually opposed oblique expansion projections.

The invention also relates in another aspect to an arrangement comprising two panels which are arranged at an angle, in particular at right-angles, with respect to each other, in particular furniture panels, and comprising a connector which is constructed as above, wherein the housing is inserted into a hole in one of the two panel sides of one panel and the expansion sleeve is inserted into a hole in an end face of the other panel, and wherein, as a result of the clamping lever which is located in the end position, the housing and the expansion sleeve are expanded and thereby tensioned in the holes. Preferably, the clamping lever in the end position is flush with the first panel.

Other advantages of the invention will be appreciated from the description, the claims and the drawings. The features mentioned above and those set out below can also be used individually or together in any combination. The embodiments shown and described are not intended to be understood to be a conclusive listing, but are instead of an exemplary nature to describe the invention.

### BRIEF DESCRIPTION OF THE DRAWINGS

In the drawings:

FIGS. 1a, 1b show a perspective view of the tool-free connector according to the invention in a non-tensioned starting position (FIG. 1a) and in a tensioned end position (FIG. 1b);

FIGS. 2a, 2b show a housing of the connector shown in FIG. 1 as a perspective view (FIG. 2a) and as a plan view (FIG. 2b);

FIGS. 3a, 3b show a clamping lever of the connector shown in FIG. 1 as a perspective view (FIG. 3a) and as a side view (FIG. 3b);

FIG. 4 shows a tension bolt of the connector shown in FIG. 1 as a perspective view;

FIGS. 5a, 5b show the connector in a non-tensioned starting position as a perspective view (FIG. 5a) and as a longitudinal cross section (FIG. 5b);

FIGS. 6a, 6b show the connector in a partially tensioned intermediate position as a perspective view (FIG. 6a) and as a longitudinal cross section (FIG. 6b);

FIGS. 7a, 7b show the connector in a tensioned end position as a perspective view (FIG. 7a) and as a longitudinal cross section (FIG. 7b);

FIG. 8 shows a perspective view of an alternative tension bolt;

FIGS. 9a, 9b show the connector according to the invention with the modified tension bolt in the non-tensioned starting position (FIG. 9a) and in the tensioned end position (FIG. 9b), in each case in cross section;

FIGS. 10a, 10b show two additional alternative tension bolts, in each case as a perspective view;

FIGS. 11a-11c show a second embodiment of the connector according to the invention starting from a non-tensioned starting position (FIG. 11a) via a partially tensioned intermediate position (FIG. 11b) into a tensioned end position (FIG. 11c);

FIGS. 12a-12c show the connector of the second embodiment starting from the tensioned end position (FIG. 12a) via the partially tensioned intermediate position (FIG. 12b) back into the non-tensioned starting position (FIG. 12c);

FIGS. 13a-13c show a third embodiment of the connector according to the invention starting from a non-tensioned starting position (FIG. 13a) via a partially tensioned intermediate position (FIG. 13b) into a tensioned end position (FIG. 13c); and

FIGS. 14a-14c show the connector of the third embodiment starting from the tensioned end position (FIG. 14a) via the partially tensioned intermediate position (FIG. 14b) back into the non-tensioned starting position (FIG. 14c).

### DETAILED DESCRIPTION OF THE PREFERRED EMBODIMENTS

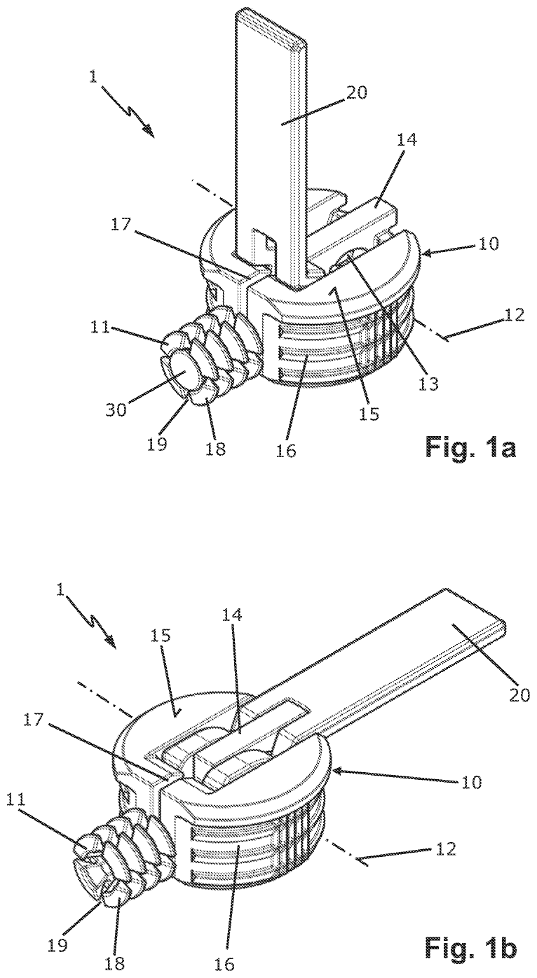

The connector 1 shown in FIGS. 1a, 1b serves to connect without tools two panels at right-angles with respect to each other.

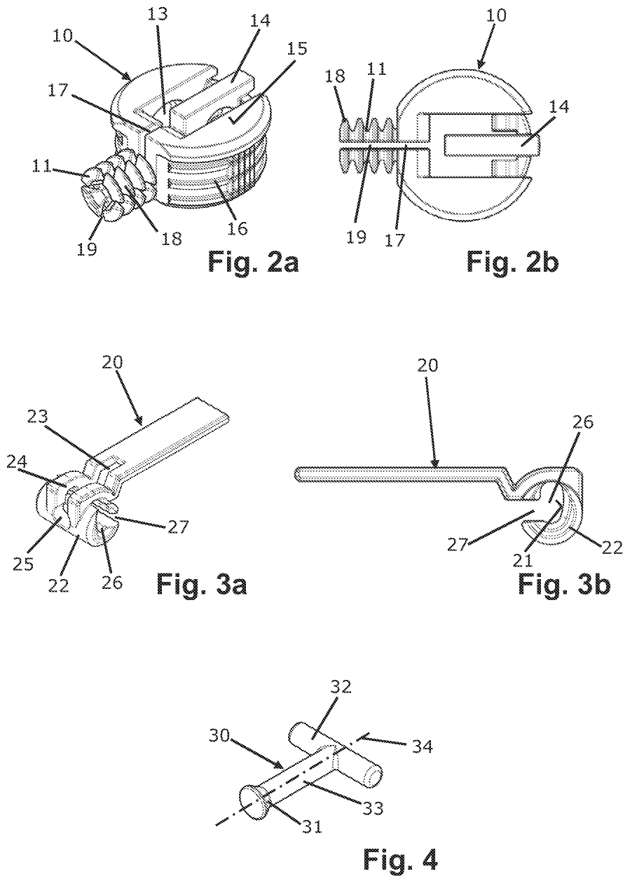

The connector 1 has the following individual components: a pot-like housing 10 which is shown in FIGS. 2a, 2b and which has a radially outwardly protruding expansion sleeve 11; a clamping lever 20 which is shown in FIGS. 3a, 3b and which is supported in the housing 10 so as to be able to be pivoted about a pivot axis 12 between a non-tensioned starting position (FIG. 1a) and a tensioned end position (FIG. 1b), having an internal tensioning contour 21 which extends eccentrically with respect to the pivot axis 12, and having a cylindrical lever end 22; and a tension bolt 30 which is shown in FIG. 4 and which has a first bolt end in the form of a bolt head 31 which is arranged in the expansion sleeve 11 and having a second bolt end in the form of a bolt head 32 which is arranged inside the housing 10 and in the cylindrical lever end 22.

The two bolt heads 31, 32 are thickened with respect to the bolt shaft 33. Preferably, the first bolt head 31 tapers in a conical manner along the bolt axis 34 in the direction toward the second bolt head 32. The second bolt head 32 is, for example, in the form of a transverse bolt which is angled at right-angles with respect to the bolt axis 34 and which is orientated in the housing 10 parallel with the pivot axis 12. The tension bolt 30 is consequently constructed in a T-shaped manner.

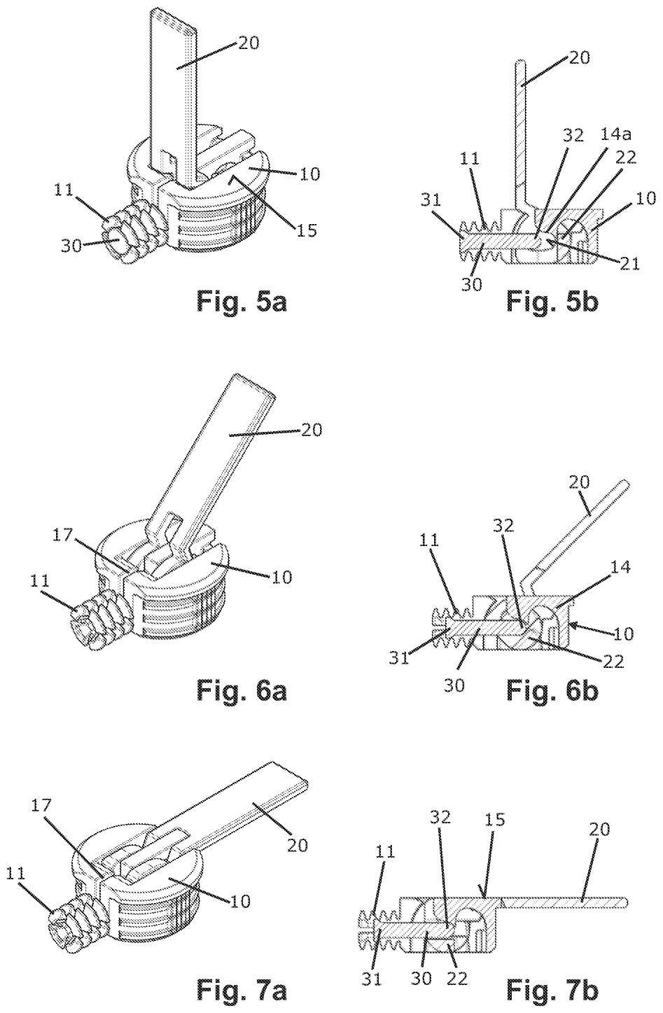

As shown in FIGS. 2, 3, the housing 10 has two bearing openings 13 which face each other and in which the cylindrical lever end 22, which extends transversely relative to the lever axis, of the clamping lever 20 is pivotably supported about the pivot axis 12. The housing 10 has between the two bearing openings 13 a central wall 14 having an internal oblique guiding contour 14a (FIG. 5b) which is directed in the direction toward the expansion sleeve 11 and the clamping lever 20 has a central slot 23. The oblique guiding contour 14a is formed on a free resilient tongue of the central wall 14 and can consequently be deflected in a resiliently flexible manner. The cylindrical lever end 22 has a circumferential slot 24, the slot width of which corresponds to the bolt shaft diameter of the clamping bolt 30 and which at one slot end thereof has a slot opening 25 which corresponds to the cross section of the first bolt head 31. The circumferential slot 24 opens in a transverse opening 26 with a radially, preferably outwardly, open transverse slot 27. On the inner opening wall of the transverse opening 26, the eccentric tensioning contour 21 is constructed in a circumferential or pivoting direction of the cylindrical lever end 22. The clamping bolt 30 is inserted with the first bolt end 31 thereof ahead through the slot opening 25 until the transverse bolt 32 is received in the transverse opening 26.

The housing 10 (FIGS. 2a, 2b) has between the housing upper side 15 and housing base a plurality of circumferential ribs 16 and between the expansion sleeve 11 and the bearing openings 13 a central longitudinal slot 17. The expansion sleeve 11 has a plurality of, in this instance, for example, four, annular sleeve ribs 18 which are arranged one behind the other in the longitudinal direction of the expansion sleeve 11 and a plurality of, in this instance, for example, four, longitudinal slots 19 which are arranged in a circumferential direction in an equidistant manner. As shown in FIG. 2b, the longitudinal slot 17 of the housing 10 and two longitudinal slots 19 of the expansion sleeve 11 are formed by a continuous slotting.

The connector 1 is shown in FIGS. 5a, 5b in the non-tensioned starting position, in FIGS. 6a, 6b in a partially tensioned intermediate position and in FIGS. 7a, 7b in the tensioned end position.

As shown in FIG. 5b, in the non-tensioned starting position the transverse bolt 32 is not engaged from behind by the eccentric tensioning contour 21 of the cylindrical lever end 22 and the clamping lever 20 preferably protrudes perpendicularly from the housing upper side 15 upwards. The transverse bolt 32 does not abut the guiding contour 14a of the central wall 14.

As shown in FIG. 6b, in the partially tensioned intermediate position the transverse bolt 32, when viewed in the direction away from the expansion sleeve 11, is partially engaged from behind by the eccentric tensioning contour 21 of the cylindrical lever end 22 and the tension bolt 30 is thereby pulled in the direction away from the expansion sleeve 11, whereby the expansion sleeve 11 is expanded outward by the conical first bolt head 31. As a result of the continuous slotting 17, the housing 10 is also expanded radially outward in this case.

As shown in FIG. 7b, in the tensioned end position the transverse bolt 32 is completely engaged from behind by the eccentric tensioning contour 21 of the cylindrical lever end 22 and the tension bolt 30 is thereby pulled further in the direction away from the expansion sleeve 11, where applicable by resiliently pushing up the guiding contour 14a of the free resilient tongue, whereby the expansion sleeve 11 by the conical first bolt head 31 and also the housing 10 are expanded further outward. In the tensioned end position, the clamping lever 20 is preferably flush the housing upper side 15, for which the central wall 14 engages in the central slot 23 of the clamping lever 20.

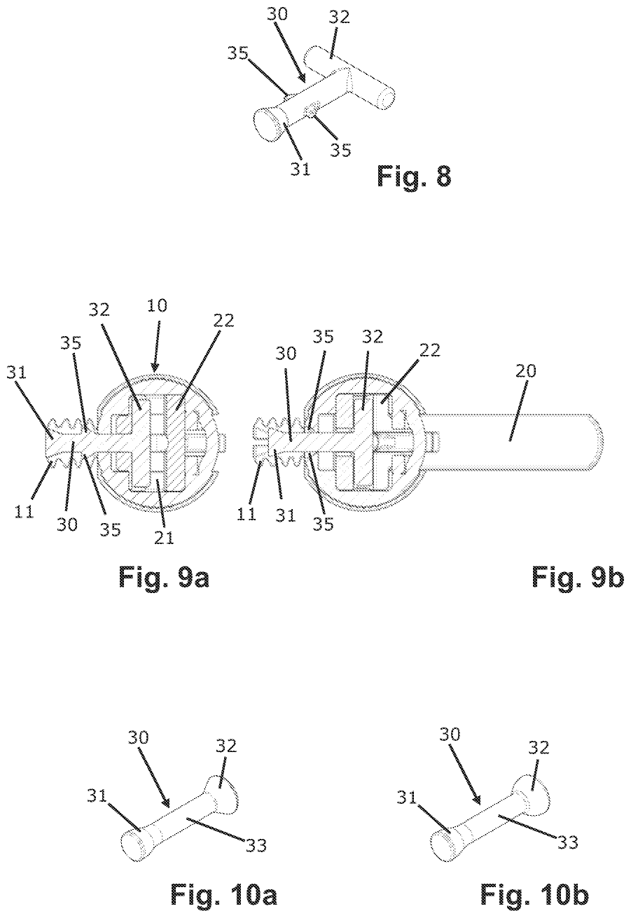

The modified clamping bolt 30 which is shown in FIG. 8 has between the conical first bolt head 31 and the transverse bolt 32 thereof two mutually opposing oblique expansion projections 35. As shown in FIGS. 9a, 9b, these expansion projections 35 are located in the starting position (FIG. 9a) inside the expansion sleeve 11 and in the end position (FIG. 9b) expand the housing 10 additionally outward along the longitudinal slot 17. In place of the expansion projections 35, the conical bolt head 31 may also extend into the housing 10 in order to thereby expand the housing 10.

In order to connect two furniture panels which are arranged at right-angles with respect to each other by means of the connector 1, the housing 10 is inserted by hand into a hole in a panel side of one, first furniture panel and is secured by the circumferential ribs 16 to prevent falling out of the hole. Subsequently, the expansion sleeve 11 is inserted into a hole in an end face of the other, second panel and engages in this instance with the sleeve ribs 18 initially only slightly in the hole wall. Subsequently, the clamping lever 20 is pressed out of the starting position through 90° downward into the end position. As a result of this rotational movement of the clamping lever 20, the expansion sleeve 11 and the housing 10 are expanded and thereby securely anchored in the holes. In the end position, the clamping lever 20 is preferably flush with the first furniture panel and can to this end be received in a corresponding recess of the first furniture panel.

When the clamping lever 20 is opened back into the starting position, the expansion sleeve 11 and the housing 10 have the tension released. By pressing down the free resilient tongue of the central wall 14 and consequently of the oblique guiding contour 14a which is directed in the direction toward the expansion sleeve 11, the tension bolt 30 can be displaced in the direction toward the expansion sleeve 11 back into the starting position thereof so that a disassembly of the connector 1 is possible.

In place of being in the form of a transverse bolt, the second bolt head 32 can alternatively also be in the form of a conical head (FIG. 10a) or a spherical head (FIG. 10b). The conical bolt head 31 may extend into the housing 10 in order to thereby expand the housing 10.

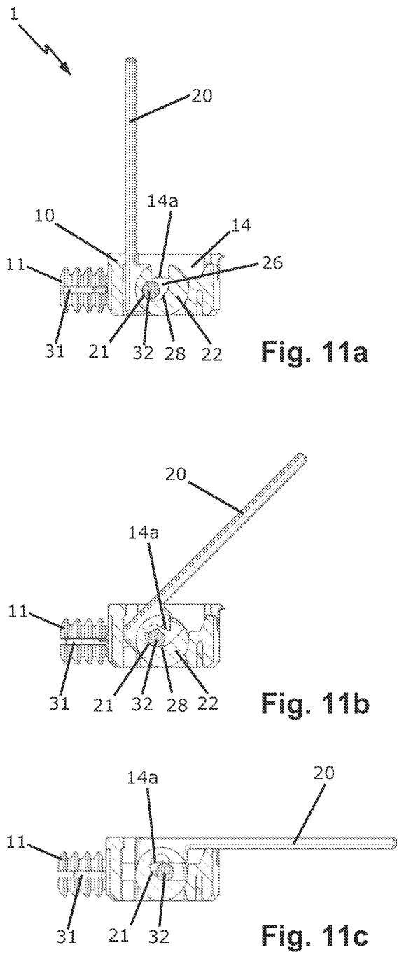

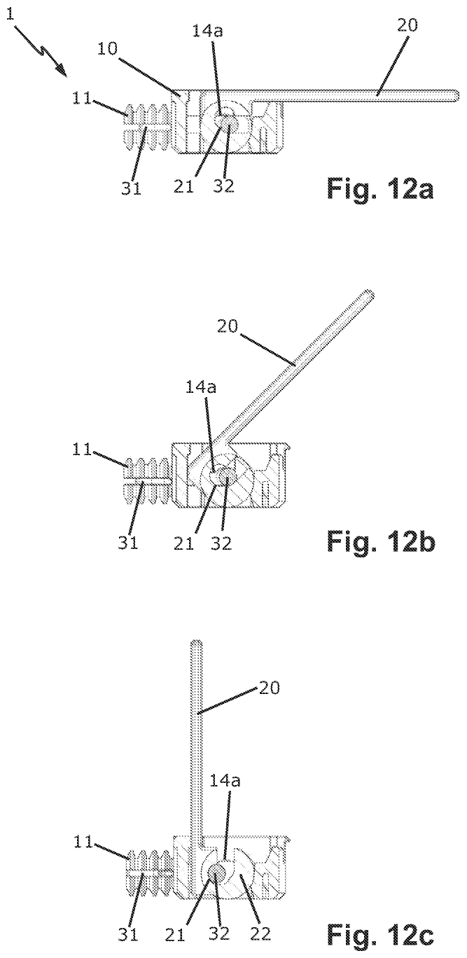

The connector 1 shown in FIGS. 11a-11c and FIGS. 12a-12c differs from the connector 1 of FIGS. 1 to 7 in that in this instance the guiding contour 14a of the central wall 14 is constructed in a concave manner and cannot be deflected. Starting from the non-tensioned starting position (FIG. 11a), by pivoting down the clamping lever 20 the second bolt head 32 is pulled by the tensioning contour 21 in the direction away from the expansion sleeve 11 into the partially tensioned intermediate position (FIG. 11b) and after overcoming a contour step or locking step 28 is pulled further into the tensioned end position (FIG. 11c). In this instance, the bolt head 32 is guided along the concave guiding contour 14a of the central wall 14 and the expansion sleeve 11 is expanded outward by the displaced first bolt head 31, which is not shown in FIGS. 11a-11c.

Starting from this tensioned end position (FIG. 12a), by pivoting the clamping lever 20 upward the second bolt head 32 is pulled by the tensioning contour 21 in the direction toward the expansion sleeve 11 into the partially tensioned intermediate position (FIG. 12b) and after overcoming the locking step 28 is pulled further into the non-tensioned starting position (FIG. 12c). In this instance, the bolt head 32 is guided along the concave guiding contour 14a of the central wall 14 and the expansion sleeve 11 has the tension from the first bolt head 31, which has been displaced back, released, which is not shown in FIGS. 12a to 12c.

Instead of at the top in a single-sided guiding contour 14a, the bolt head 32 can also be force-guided at both sides in a slot-like slotted guiding member (not shown) of the central wall 14 or the housing 10 in the direction away from and toward the expansion sleeve 11.

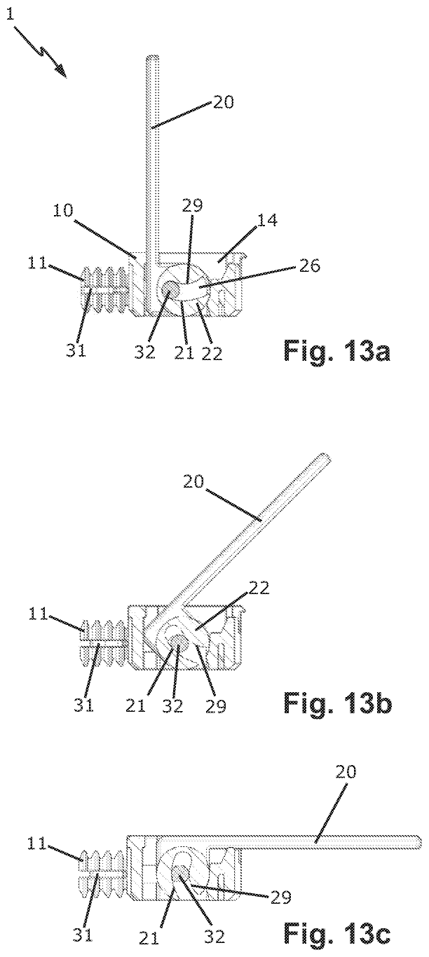

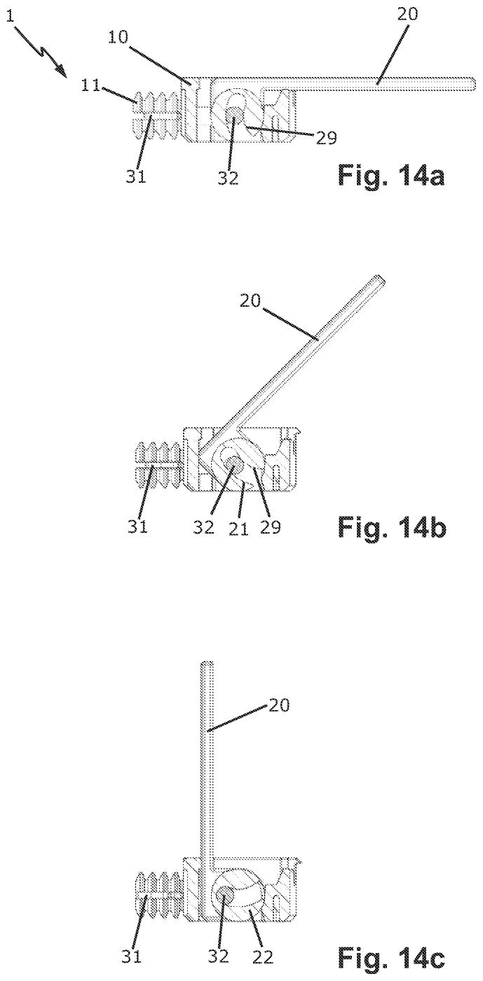

The connector 1 shown in FIGS. 13a-13c and FIGS. 14a-14c differs from the connector 1 of FIGS. 1 to 7 in that in this instance the central wall 14 has no guiding contour for the second bolt head 32 and the transverse opening 26 is in the form of a curved, slit-like slotted guiding member with an eccentric tensioning contour 21 and with an eccentric pressure contour 29 for the second bolt head 32. Starting from the non-tensioned starting position (FIG. 13a), by pivoting the clamping lever 20 downward the second bolt head 32 is pulled by the tensioning contour 21 in the direction away from the expansion sleeve 11 into the partially tensioned intermediate position (FIG. 13b) and further into the tensioned end position (FIG. 13c). In this instance, the expansion sleeve 11 is expanded outward away from the displaced first bolt head 31, which is not shown in FIGS. 13a-13c.

Starting from this tensioned end position (FIG. 14a), by pivoting the clamping lever 20 upward the second bolt head 32 is pulled by the pressure contour 29 in the direction toward the expansion sleeve 11 into the partially tensioned intermediate position (FIG. 14b) and further into the non-tensioned starting position (FIG. 14c). In this instance, the expansion sleeve 11 has the tension from the first bolt head 31, which has been displaced back, released, which is not shown in FIGS. 14a-14c.

What is claimed is:

1. A connector for connecting without tools two panels which are at an angle with respect to each other, comprising:
a pot-like housing having a radially outwardly protruding expansion sleeve;
a clamping lever which is supported in the housing configured to be able to be pivoted about a pivot axis between a non-tensioned starting position and a tensioned end position and which has a tensioning contour which extends eccentrically with respect to the pivot axis; and
a tension bolt having a bolt shaft, having a first bolt end in the form of a first bolt head which is thickened with respect to the bolt shaft and which is arranged in the expansion sleeve, and having a second bolt end in the form of a second bolt head which is thickened with respect to the bolt shaft and which is arranged inside the housing;
wherein the second bolt head, when viewed in the direction away from the expansion sleeve, is engaged from behind by the eccentric tensioning contour of the clamping lever in the tensioned starting position and is pulled in the direction away from the expansion sleeve whereby the expansion sleeve is expanded by the first bolt head.

2. The connector as claimed in claim 1, wherein the clamping lever in the non-tensioned starting position protrudes upwards from the housing upper side and extends in the tensioned end position parallel with the housing upper side.

3. The connector as claimed in claim 1, wherein the first bolt head is tapered in the direction toward the second bolt head.

4. The connector as claimed in claim 1, wherein the second bolt head is in the form of a spherical or conical head or a transverse bolt which is angled at right-angles with respect to the bolt axis.

5. The connector as claimed in claim 1, wherein the housing has at least one bearing opening, in which the cylindrical lever end, which extends transversely relative to the lever axis, of the clamping lever is pivotably supported about the pivot axis.

6. The connector as claimed in claim 1, wherein the housing has two mutually facing bearing openings, in which the cylindrical lever end of the clamping lever is pivotably supported about the pivot axis.

7. The connector as claimed in claim 6, wherein the housing has between the two bearing openings a central wall.

8. The connector as claimed in claim 7, wherein the central wall has a guiding contour for the second bolt head of the tension bolt.

9. The connector as claimed in claim 8, wherein the guiding contour is arranged on a resilient tongue of the central wall.

10. The connector as claimed in claim 1, wherein the eccentric tensioning contour is arranged internally on a transverse opening of the housing-side lever end of the clamping lever.

11. The connector as claimed in claim 10, wherein the transverse opening is in the form of a slit-like slotted guiding member with the eccentric tensioning contour and with an eccentric pressure contour for the second bolt head.

12. The connector as claimed in claim 1, wherein the expansion sleeve has at least one sleeve rib which extends in the circumferential direction of the expansion sleeve.

13. The connector as claimed in claim 1, wherein the expansion sleeve has a plurality of sleeve ribs which are arranged one behind the other in a longitudinal direction.

14. The connector as claimed in claim 1, wherein the expansion sleeve has at least one longitudinal slot.

15. The connector as claimed in claim 1, wherein the expansion sleeve has a plurality of longitudinal slots.

16. The connector as claimed in claim 1, wherein the housing has a central longitudinal slot.

17. The connector as claimed in claim 1, wherein the tension bolt has between the two bolt ends thereof two mutually opposed oblique expansion projections for expanding the housing.

18. An arrangement comprising the two panels which are arranged at an angle with respect to each other, and comprising the connector as claimed in claim 1, wherein the housing is inserted in a hole in a panel side of one panel and the expansion sleeve is inserted into a hole in an end face of the other panel, and wherein, as a result of the clamping lever which is located in the end position, the housing and the expansion sleeve are expanded and thereby tightened in the holes.

19. The arrangement as claimed in claim 18, wherein the clamping lever in the end position is flush with the panel side of the first panel.
